(19) United States
(12) Patent Application Publication
(10) Pub. No.: US 2014/0324379 A1
(43) Pub. Date: Oct. 30, 2014

(54) SYSTEM AND METHOD FOR PREDICTING TEMPERATURE OF BATTERY

(71) Applicants: Hyundai Motor Company, Seoul (KR); SNU R&DB FOUNDATION, Seoul (KR); Kia Motors Corporation, Seoul (KR)

(72) Inventors: Gun Goo LEE, Suwon-si (KR); Byeng Dong YOUN, Seoul (KR); Tae Jin KIM, Busan (KR)

(73) Assignees: HYUNDAI MOTOR COMPANY, Seoul (KR); SNU R&DB FOUNDATION, Seoul (KR); KIA MOTORS CORPORATION, Seoul (KR)

(21) Appl. No.: 14/080,563

(22) Filed: Nov. 14, 2013

(30) Foreign Application Priority Data
Apr. 26, 2013 (KR) 10-2013-0046469

(51) Int. Cl. G01K 13/00

(52) U.S. Cl. CPC G01K 13/00
USPC 702/130

(57) ABSTRACT

A method and a system for predicting a temperature of a battery include the steps of measuring a temperature at an entrance of a battery air conditioning line, an air volume of the battery air conditioning line, and a current amount of the battery. Deriving a heating value of the battery based on the measured data and the temperatures at multiple points of the battery by substituting the temperature at the entrance, the air volume, the current amount, and the heating value into an operation logic.

### CROSS REFERENCE TO RELATED APPLICATION

This application claims under 35 U.S.C. §119(a) the benefit of priority to Korean Patent Application No. 10-2013-0046469, filed on Apr. 26, 2013, the entire contents of which are incorporated herein by reference.

### TECHNICAL FIELD

The present disclosure relates to a system and a method for indirectly predicting a temperature of a battery, and more particularly, to a system and a method for indirectly predicting a temperature of a battery without directly measuring each module of a battery or each cell for a vehicle.

### BACKGROUND

A lithium ion battery, which has been used for green cars, such as a hybrid car, a fuel cell car, an electric car, and the like, generally varies in performance depending on a temperature of a battery. High temperature accelerates deterioration of a battery, and low temperature reduces available energy range and creates problems, such as lithium precipitation, and the like, when conducting a large current.

Therefore, it is very important to manage a temperature of a battery system. In general, a temperature sensor disposed in the battery module monitors the battery temperature. A cooling fan controls a shift level in the case of an air cooling type or controls a flux of cooling water in the case of a water cooling type, depending on the temperature of the battery. However, due to the occurrence of defects in temperature sensors, unnecessary repair costs may occur, and the difficulty in a hardware layout design for connecting the plurality of temperature sensors, may increase part costs.

Accordingly, the present disclosure accurately predicts a temperature distribution of a battery system while reducing the number of temperature sensors to reduce costs, reduce unnecessary repair costs due to sensor defects, and simplify a hardware layout according to the use of the minimum number of temperature sensors.

The matters described as the related art have been provided only for assisting in the understanding for the background of the present disclosure and should not be considered as corresponding to the related art known to those skilled in the art.

### SUMMARY

An aspect of the present disclosure provides a method and a system for accurately predicting a temperature distribution of a battery system while minimizing the number of temperature sensors of a battery to reduce costs according to the reduction in the number of temperature sensors, reduce unnecessary repair costs due to sensor defects, and simplify a hardware layout according to the use of the minimum number of temperature sensors.

According to an exemplary embodiment of the present disclosure, a method for predicting a temperature of a battery includes measuring a temperature at an entrance of a battery air conditioning line, an air volume of the battery air conditioning line, and a current amount of the battery; deriving a heating value of the battery based on the measured data; and after deriving the heating value, deriving the temperatures at multiple points of the battery by substituting the temperature at the entrance, air volume, the current amount, and the heating value into an operation logic.

In the measuring, the air volume may be derived from an operation load of a blower of the battery air conditioning line.

In the deriving, the heating value of the battery may be derived by substituting the current amount of the battery into the previously prepared data map.

The operation logic may be an artificial neural network model including an input layer, a hidden layer, and an output layer.

The input layer may be an input matrix including the temperature at the entrance, the air volume, the current amount, and the heating value.

In the hidden layer, a first preparation matrix may be derived by multiplying a first weight matrix by the input matrix and adding a first bias matrix to the product.

In the hidden layer, the input matrix may be normalized. The first preparation matrix may be derived by multiplying the first weight matrix by the normalized matrix and adding the first bias matrix to the product.

In the hidden layer, a first result matrix may be derived by substituting the first preparation matrix into the following transfer function.

$${a}^{1} = \frac{2}{1 + {e}^{- 2 \times {n}^{1}}} - 1$$

(n¹ is a first preparation matrix and a¹ is a first result matrix)

In the output layer, a second result matrix may be derived by multiplying a second weight matrix by the first result matrix and adding a second bias matrix to the product.

In the output layer, a final matrix configured of the temperatures at multiple points of the battery may be derived by non-normalizing the second result matrix.

According to another exemplary embodiment of the present disclosure, a system for predicting a temperature of a battery includes a temperature sensor disposed at an entrance of a battery air conditioning line and a blower of the battery air conditioning line. A current sensor measures a current amount of the battery, and a controller derives a heating value of the battery based on data of the sensors and the blower. The controller further substitutes a temperature at an entrance of a battery air conditioning line, an air volume of the battery air conditioning line, a current amount of the battery, and the heating value of the battery into an operation logic to derive temperatures at multiple points of the battery.

### BRIEF DESCRIPTION OF THE DRAWINGS

FIG. 1 is a configuration diagram of a system for predicting a temperature of a battery according to an embodiment of the present disclosure.

FIG. 2 is a flow chart of a method for predicting a temperature of a battery according to an exemplary embodiment of the present disclosure.

FIG. 3 is a block diagram of the method for predicting a temperature of a battery illustrated in FIG. 2.

FIG. 4 is a diagram for describing an input layer of a method for predicting a temperature of a battery illustrated in FIG. 2.

FIGS. 5 and 6 are diagrams for describing a hidden layer of the method for predicting a temperature of a battery illustrated in FIG. 2.

FIG. 7 is a diagram for describing an output layer of the method for predicting a temperature of a battery illustrated in FIG. 2.

### DETAILED DESCRIPTION

Hereinafter, a method and a system for predicting a temperature of a battery according to embodiments of the present disclosure will be described with reference to the accompanying drawings.

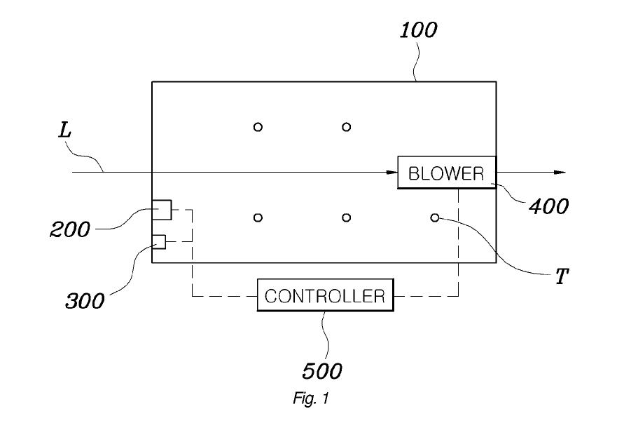

FIG. 1 is a configuration diagram of a system for predicting a temperature of a battery according to an embodiment of the present disclosure. The system for predicting a temperature of a battery according to the exemplary embodiment of the present disclosure includes temperature sensors 200 disposed at an entrance of a battery air conditioning line L, a blower 400 of the battery air conditioning line L, a current sensor 300 measuring a current amount of a battery, and a controller 500 deriving a heating value of the battery 100 based on data of the temperature sensors and the blower 400, and substituting temperature at the entrance of the battery air conditioning line L, an air volume of the battery air conditioning line, the current amount of the battery, and the heating value of the battery into an operation logic to derive temperatures at multiple points of the battery.

A large-capacity battery for cars, such as a hybrid car, an electric car, and a fuel cell car, may be applied to the case in which the battery includes a separate air conditioning system.

Air conditioned air is introduced into the battery, circulated, and discharged to prevent the battery from overheating or preheating the battery. For the air conditioning control, an inefficient method for checking the temperature of each portion of the battery and installing the temperature sensors at each portion of the battery to detect an abnormal battery cell may be avoided. The temperature of each portion of the battery may be accurately predicted to reduce costs and prevent battery defects or failure of the temperature sensors.

The system for predicting a temperature of a battery according to the exemplary embodiment of the present disclosure includes the temperature sensors 200 disposed at the entrance of the battery air conditioning line L. The temperature sensor 200 is disposed at the entrance of the battery air conditioning line to first measure the temperature of the conditioned temperature.

The blower 400 of the battery air conditioning line circulates air in the air conditioning line L and may be disposed anywhere the air may flow. Here, the blower 400 is disposed at a discharge portion.

The current sensor 300 measures the current amount of the battery.

The sensors may detect the introduced air temperature at the entrance of the battery, the current amount of the battery, and the air volume of the battery. The air volume may be easily detected by operating shift level of the blower. The heating value of the battery may be tracked based on the current amount of the battery.

The controller 500 calculates an estimated temperature of each portion of the battery. That is, the controller 500 derives the heating value of the battery based on the sensors and the blower and substitutes the temperature at the entrance of the battery air conditioning line, the air volume of the battery air conditioning line, the current amount of the battery, and the heating value of the battery into the operation logic to derive the temperatures at multiple points.

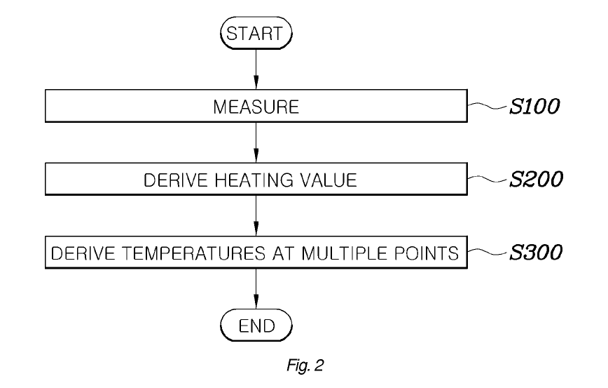

FIG. 2 is a flow chart of a method for predicting a temperature of a battery according to an exemplary embodiment of the present disclosure. The method for predicting a battery temperature includes the steps of: measuring the temperature at the entrance of the battery air conditioning line, the air volume of the battery air conditioning line, and the current amount of the battery (S100). Deriving the heating value of the battery based on the measured data (S200); and after deriving the heating value, deriving the temperatures at multiple points of the battery by substituting the temperature at the entrance, the air volume, the current amount, and the heating value into the operation logic (S300).

The controller measures the temperature at the entrance of the battery air conditioning line, the air volume of the battery air conditioning line, and the current amount of the battery. Herein, the heating value of the battery is tracked based on the current amount of the battery.

The temperature at the entrance, the air volume, the current amount, and the heating value are substituted into the operation logic to derive the temperatures at multiple points of the battery. In the measuring, the air volume is derived from the operation load of the blower of the battery air conditioning line.

In the deriving the heating value (S200), the heating value of the battery is derived by substituting the current amount of the battery into the data map, in which the data map is previously prepared by an experiment. The data map uses the current amount of the battery as an input to obtain the heating value corresponding thereto as an experimental value.

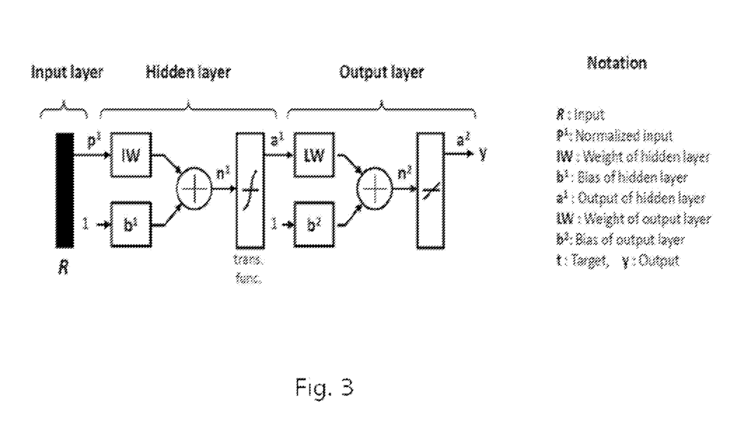

FIG. 3 is a block diagram of the method for predicting a temperature of a battery illustrated in FIG. 2. FIG. 3 illustrates that the operation logic is based on an artificial neural network model including an input layer, a hidden layer, and an output layer. The artificial neural network (ANN) model is a mathematical model that represents brain function characteristics in a computer simulation. The artificial neural network indicates the models in which an artificial neuron (node) forms a network by coupling synapses to change strength of synapses through learning so as to have problem solving abilities. The artificial neural network may use an error back-propagation method to indicate a multilayer perceptron (MLP), but is not limited thereto.

The artificial neural network including supervised learning optimized problem solving by inputting a signal (correct answer), and non-supervised learning does not require a signal. The supervised learning is used for a clear solution, and the non-supervised learning is used in the case of data clustering. In order to reduce dimensions, a linearly inseparable problem may obtain a reply with a relatively less computational quantity based on multi-dimensional data, such as images, statistics, and the like. Thus, the artificial neural network has been applied in various fields, such as pattern recognition, data mining, and the like. The artificial neural network may be configured of a special computer but mainly configured of application software in a general computer.

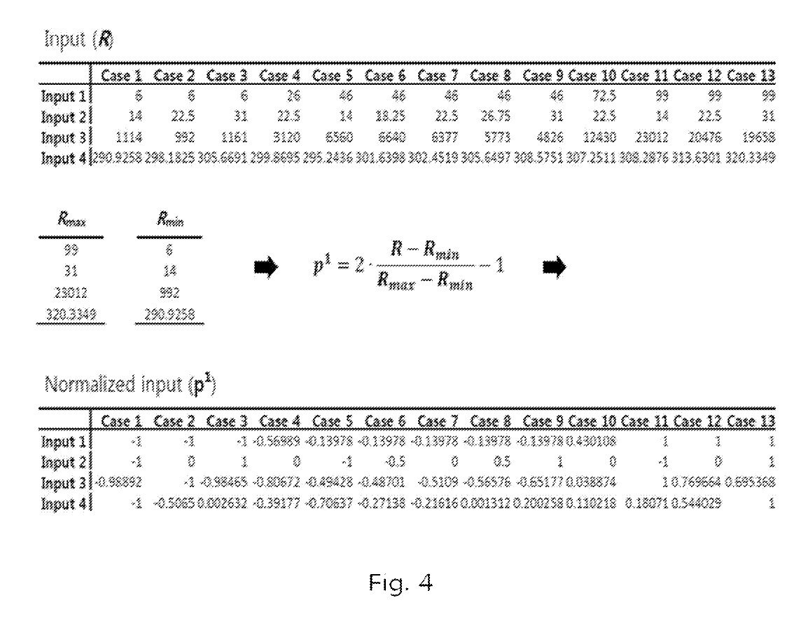

The artificial neural network model is basically configured of an input layer, a hidden layer, and an output layer. FIG. 3 illustrates a computation order depending on a three-stage layer. FIG. 4 is a diagram for describing the input layer of the method for predicting a temperature of a battery illustrated in FIG. 2 and a value input to the input layer is shown in a matrix form. That is, the input layer may be an input matrix of the temperature at the entrance, the air volume, the current amount, and the heating value.

Input 1 represents a current value of a battery, input 2 represents the temperature at the entrance of the battery, input 3 represents the heating value of the battery, and input represents the conditioned air volume of the battery. Further, the data combination is measured to form a plurality of cases and to complete an input matrix R in FIG. 3.

Referring to FIG. 3, in the hidden layer, the input matrix R is normalized. A first preparation matrix n¹ is derived by multiplying a first weight matrix IW by a normalized matrix p¹ and adding a first bias matrix b¹ to the product.

FIG. 4 illustrates the normalization method. The normalization method is capable of finding maximum and minimum values for each item among respective measured input values and normalizing all the data based on the maximum and minimum values by Equation 1.

$${p}^{1} = 2 \cdot \frac{R - {R}_{min}}{{R}_{max} - {R}_{min}} - 1 \qquad [ Equation 1 ]$$

The normalized data is represented as the normalized matrix p¹ in FIG. 4.

The first preparation matrix n¹ is derived by multiplying the first weight matrix IW by the normalized matrix p¹ and adding the first bias matrix b¹ to the product in the hidden layer. This may be represented by Equation 2.

n¹=IW·p¹+b¹ [Equation 2]

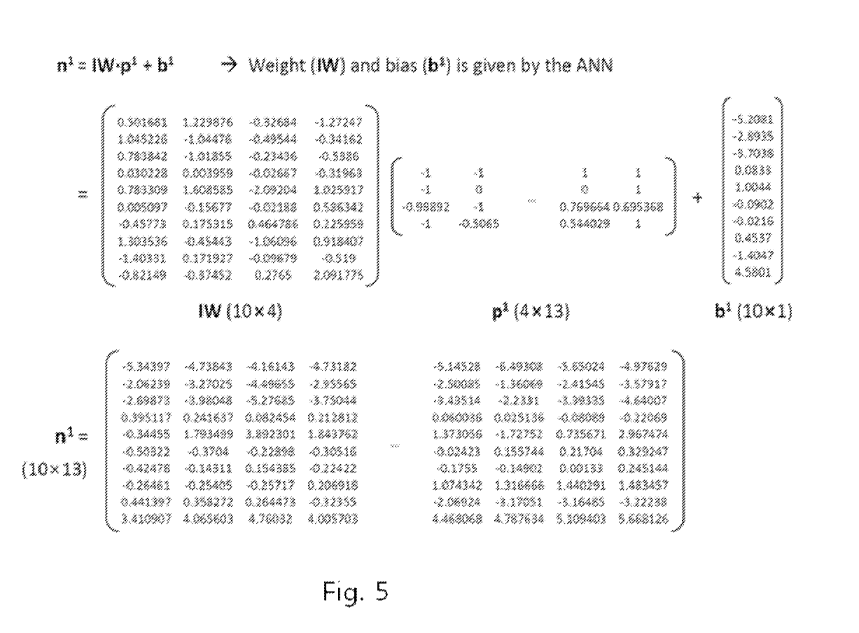

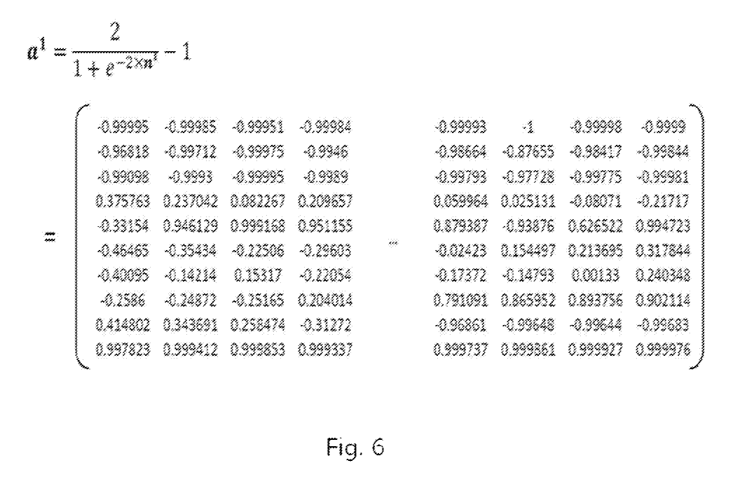

FIGS. 5 and 6 are diagrams describing the hidden layer of the method for predicting a temperature of a battery illustrated in FIG. 2.

The first weight matrix IW and the first bias matrix b¹ illustrated in FIG. 5 are previously prepared matrix values. The first preparation matrix n¹ is derived by multiplying the first weight matrix IW by the matrix p¹ that is normalized by substituting the matrix value illustrated above thereinto and adding the first bias matrix b¹ to the product.

Referring to FIG. 6, the first preparation matrix n¹ is substituted into a transfer function in Equation 3 to derive a first result matrix a¹.

$${a}^{1} = \frac{2}{1 + {e}^{- 2 \times {n}^{1}}} - 1 \qquad [ Equation 3 ]$$

(n¹ is a first preparation matrix and a¹ is a first result matrix)

As illustrated in FIG. 3, a second result matrix n² is derived by multiplying a second weight matrix LW by the first result matrix a¹ and adding a second bias matrix b² to the product. A final matrix configured of the temperatures at multiple points T of the battery in FIG. 1 is derived by non-normalizing the second result matrix n².

Herein, the second weight matrix LW and the second bias matrix b² were identically used with the first weight matrix IW and the first bias matrix b¹. This may be represented in Equation 4.

n²=y=LW·a¹+b² [Equation 4]

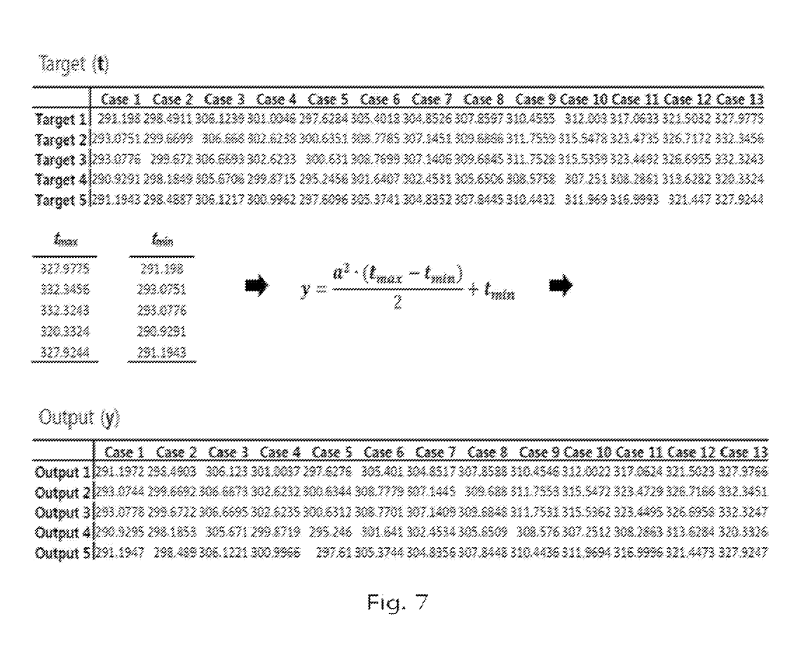

The second result matrix n² of FIG. 7 is derived by a method, such as Equation 2. Referring to FIGS. 3 and 7, the second result matrix n² is used identical to an a2 matrix, without substituting into a transfer function. The a2 matrix is non-normalized based on the maximum value t max and minimum value t_min by Equation 5 deriving a final matrix y for the temperatures at multiple points of the battery.

$$y = \frac{{a}^{2} \cdot ( {t}_{max} - {t}_{min} )}{2} + {t}_{min} \qquad [ Equation 5 ]$$

The values of the final matrix are derived as temperature values at multiple points, for example, the outputs 1 to 5 points of the battery correspond to each case. In other words, the temperature values at five points may be appreciated from four input values and importantly, no temperature sensor is used at the remaining portions other than at the entrance of the battery in the inside of the battery.

Accordingly, the temperatures of each portion of the battery may be accurately predicted by the above-mentioned processes, such that the number of temperature sensors may be reduced.

According to the exemplary embodiments of the present disclosure, the method and system for predicting a temperature of a battery having the above-mentioned structure can accurately predict the temperature distribution of a battery system while minimizing the number of temperature sensors monitoring temperature of a battery to reduce costs according to the reduction in the number of temperature sensors, reduce unnecessary repair costs due to the sensor defects, and simplify the hardware layout according to the use of the minimum number of temperature sensors.

Although the present disclosure has been shown and described with respect to specific exemplary embodiments, it will be obvious to those skilled in the art that the present disclosure may be variously modified and altered without departing from the spirit and scope of the present disclosure as defined by the following claims.

What is claimed is:

1. A method for predicting a temperature of a battery, comprising the steps of:
measuring a temperature at an entrance of a battery air conditioning line, an air volume of the battery air conditioning line, and a current amount of the battery;
deriving a heating value of the battery based on the measured data; and
after deriving the heating value, deriving the temperatures at multiple points of the battery by substituting the temperature at the entrance, the air volume, the current amount, and the heating value into an operation logic.

2. The method of claim 1, wherein in the measuring step, the air volume is derived from an operation load of a blower of the battery air conditioning line.

3. The method of claim 1, wherein in the step of deriving a heating value the heating value of the battery is derived by substituting the current amount of the battery into a previously prepared data map.

4. The method of claim 1, wherein the operation logic is an artificial neural network model including an input layer, a hidden layer, and an output layer.

5. The method of claim 4, wherein the input layer is an input matrix including the temperature at the entrance, the air volume, the current amount, and the heating value.

6. The method of claim 5, wherein in the hidden layer, a first preparation matrix is derived by multiplying a first weight matrix by the input matrix and adding a first bias matrix to the product.

7. The method of claim 6, wherein in the hidden layer, the input matrix is normalized and the first preparation matrix is derived by multiplying the first weight matrix by the normalized matrix and adding the first bias matrix to the product.

8. The method of claim 7, wherein in the hidden layer, a first result matrix is derived by substituting the first preparation matrix into the following transfer function.
$${a}^{1} = \frac{2}{1 + {e}^{- 2 \times {n}^{1}}} - 1$$
(n¹ is a first preparation matrix and a¹ is a first result matrix)

9. The method of claim 8, wherein in the output layer, a second result matrix is derived by multiplying a second weight matrix by the first result matrix and adding a second bias matrix to the product.

10. The method of claim 9, wherein in the output layer, a final matrix configured of the temperatures at multiple points of the battery is derived by non-normalizing the second result matrix.

11. A system for predicting a temperature of a battery, comprising:
a temperature sensor disposed at an entrance of a battery air conditioning line, a blower of the battery air conditioning line, and a current sensor measuring a current amount of the battery; and
a controller deriving a heating value of the battery based on data of the sensors and the blower and substituting the temperature at the entrance of the battery air conditioning line, an air volume of the battery air conditioning line, the current amount of the battery, and the heating value of the battery into an operation logic to derive the temperatures at multiple points of the battery.
